(19) United States
(12) Patent Application Publication
(10) Pub. No.: US 2004/0042225 A1
(43) Pub. Date: Mar. 4, 2004

(54) Vehicle interior lighting assembly

(76) Inventors: Onward K. Dealey, Waterford, MI (US); Ben V. Domas, Oakland, MI (US); Alvin D. McCauley, Holly, MI (US)

Correspondence Address: REISING, ETHINGTON, BARNES, KISSELLE, P.C., P O BOX 4390, TROY, MI, 48099-4390, US

(21) Appl. No.: 10/430,551

(22) Filed: May 6, 2003

Related U.S. Application Data
(60) Provisional application No. 60/407,167, filed on Aug. 30, 2002.

(51) Int. Cl. B60Q 1/00

(52) U.S. Cl. 362/487

(57) ABSTRACT

A vehicle interior lighting assembly that includes a cold cathode discharge tube carried by a lamp housing having a lens. The tube emits light through the lens when energized by electrical current. Current paths extend from respective electrodes of the cold cathode discharge tube and are connectable to an external power source 19 to deliver electrical current from the source 19 to the tube sufficient to illuminate the tube. Supported in the passenger compartment of a vehicle that flexes, the lamp housing supports and protects the tube from breakage when forces that the flexing vehicle transmits to the lamp housing cause the lamp housing to flex.

### CROSS-REFERENCE TO RELATED APPLICATION

This application claims priority from Provisional Application No. 60/407,167, filed Aug. 30, 2002, and entitled “Vehicle Interior Lighting Assembly”.

### BACKGROUND OF THE INVENTION

1. Field of the Invention

This invention relates generally to a vehicle interior lighting assembly for illuminating the interior of a vehicle.

2. Description of the Related Art Including Information Disclosed Under 37 CFR 1.97 and 1.98

Cold cathode discharge tubes, also known as cold cathode fluorescent lights (CCFLs), are known for use as light source throughout. As is described in detail in the Appendix, cold cathode discharge tubes produce light by passing electric current through a gas or vapor. This causes an ionization process in which electrons are separated from their charges and collide with one another to produce a glow. The power supply for a cold cathode tube typically includes a magnetic or electronic ballast. Heating above ambient temperature is not required for a cold cathode tube to produce light. The tubes are made of glass and are therefore comparatively brittle and prone to breakage. The glass tubes may be phosphor coated to emit various color temperatures and can be contoured to a variety of different shapes to suit different applications. So long as cold cathode tubes are not subjected to shocks or bending, torsional or vibration loads sufficient to shatter them, their operational longevity is such that in many applications they can effectively serve as permanent light source.

It is known for lighting assemblies to include cold cathode discharge tubes supported within lamp housings. Typically, in such an assembly, a portion of the housing serves as a reflector and another portion serves as a lens. When energized, the cold cathode tube emits light that either passes directly through the lens or reflects off the reflector portion and passes through the lens. It's also known for such a lighting assembly to include a receptacle that is permanently fixed to a support structure and removably receives the lamp housing so that the cold cathode discharge tube and lamp housing can be removed and replaced as a unit.

For example, U.S. Pat. No. 4,186,432 issued Jan. 29, 1980 to Martin Hammicker, discloses a vehicle interior lighting assembly including a lamp housing having a translucent lens and a cold cathode discharge tube enclosed within the lamp housing in a position to emit light through the lens. The vehicle interior lighting assembly of the Hammicker patent includes a first set of electrical connectors coupled to electrodes of the cold cathode discharge tube and providing a current path to the tube from external electrodes of the lamp housing. The Hammicker lighting assembly also includes a receptacle that's supported on a mineshaft wall and that removably receives the lamp housing. As such, the lamp housing and the cold cathode tube within it can be removed and replaced as a unit. The vehicle interior lighting assembly disclosed in the Hammicker patent also includes a second set of electrical connectors disposed in the receptacle and positioned to couple with the external housing electrodes and an outside power source. The first and second sets of electrical connectors provide a current path between the tube and the outside power source.

In addition, U.S. Pat. No. 4,940,921 issued Jul. 10, 1990 to Helling et al., discloses a receptacle that's supported on a ceiling of a room in a building and removably receives a sealed disposable lamp housing that includes a clear lens. The vehicle interior lighting assembly of the Helling et al. patent also includes a plurality of elongated cold cathode discharge tubes sealed within the lamp housing.

However, a vehicle interior lighting assembly constructed according to either the Hammicker patent or the Helling et al. patent cannot protect a cold cathode tube against torsional, vibration and shock loads applied to the assembly that would be experience in a moving vehicle. Nor can such an assembly support elongated cold cathode discharge tubes end-to-end in an elongated cornice lighting fixture supported longitudinally along the length of a passenger compartment.

What is needed is a vehicle interior lighting assembly that can support and protect elongated cold cathode discharge tubes against torsional, vibration and shock loads. What is also needed is such a vehicle interior lighting assembly that can support elongated cold cathode discharge tubes end-to-end in an elongated cornice lighting fixture supported longitudinally along the length of a passenger compartment of a vehicle.

### BRIEF SUMMARY OF THE INVENTION

A vehicle interior lighting assembly is provided that includes a lamp housing having a lens and a cold cathode discharge tube carried by the lamp housing. The tube is configured to emit light through the lens when energized by electrical current. The vehicle interior lighting assembly also includes current paths extending from respective electrodes of the cold cathode discharge tube, connectable to an external power source, and configured to deliver electrical current from the source to the tube sufficient to illuminate the tube. The lamp housing is additionally configured to support and protect the tube from breakage in the passenger compartment of a vehicle that flexes and transmits related forces to the assembly causing the housing to flex. Therefore, a vehicle interior lighting assembly constructed according to the invention is able to protect cold cathode discharge tubes in the interior of a vehicle against breakage that might otherwise result due to flexing of the vehicle structure.

According to another aspect of the invention, the housing including a pair of lamp support bushings disposed at opposite ends of the housing and supporting opposite ends of a cold cathode discharge tube. The bushings are configured to limit torsional, shock, vibration and/or bending forces that the housing can apply to the tube as the housing flexes with a vehicle the housing is supported on.

According to another aspect of the invention, each bushing includes a flexible annular cuff that fits around an end of a cold cathode tube to flexibly support the tube.

According to another aspect of the invention, each bushing comprises polyurethane foam.

According to another aspect of the invention, the housing comprises an extruded polycarbonate lens/reflector tube.

According to another aspect of the invention, the tube includes the lens and a reflector portion that is co-extruded with the lens.

According to another aspect of the invention, the lens and reflector are extruded separately, then joined together by sonic weld or other suitable means.

According to another aspect of the invention, the housing comprises a pair of end caps configured to close opposite ends of the tube and to carry the lamp support bushings in positions such that the bushings support the cold cathode discharge tube in a position spaced from a continuous inner wall of the lens/reflector tube. This prevents the lens/reflector tube from transmitting or applying torsional or bending stresses to the cold cathode discharge tube.

According to another aspect of the invention, at least one of the end caps includes a wire shield that extends axially from a wall portion of the end cap. The wire shield is configured to block passenger access to electrical wiring leading from the housing to a vehicle power source.

According to another aspect of the invention, the assembly includes a plurality of tubes and lamp housings arranged end-to-end and longitudinally along an elongated vehicle interior compartment. This arrangement provides an extended line of illumination along the length of such a compartment.

According to another aspect of the invention, the lamp housing is a removable self-contained cartridge and the assembly includes a vehicle lighting fixture that includes a receptacle configured to removably receive the cartridge. This allows the cold cathode discharge tube and cartridge to be removed and replaced as a unit.

According to another aspect of the invention, the cartridge is sealed to prevent contaminants such as dust and insects from inhibiting or otherwise modifying the emission of light from the cartridge.

According to another aspect of the invention, the cartridge is hermetically sealed to prevent water vapor from entering the housing and clouding the lens.

According to another aspect of the invention, the assembly includes a plurality of the cartridges and the vehicle lighting fixture includes a receptacle configured to receive and support the cartridges longitudinally along a vehicle passenger compartment in an end-to-end arrangement.

According to another aspect of the invention, the receptacle is configured to removably receive and support the cartridges longitudinally along a vehicle passenger compartment in an end-to-end arrangement.

According to another aspect of the invention, the current paths each include an electrical contact supported in one of the end caps and coupled to one of two electrodes of the cold cathode discharge tube, and a wire that is coupled to and extends from the contact and is connectable to a vehicle electrical power distribution system

According to another aspect of the invention, a method is provided for installing a lamp cartridge in an existing vehicle lighting system. According to the method, a vehicle is provided having an existing interior lighting fixture comprising a lamp housing for receiving a lamp. A cartridge is then shaped to fit within the lamp housing. The custom-shaped cartridge is then installed in the lamp housing and is connected to an electrical distribution system of the vehicle.

### BRIEF DESCRIPTION OF THE SEVERAL VIEWS OF THE DRAWINGS

These and other features and advantages of the invention will become apparent to those skilled in the art in connection with the following detailed description and drawings, in which:

FIG. 1 is an end view of an interior lighting assembly constructed according to the invention and shown incorporated into a cornice lighting fixture of a bus;

FIG. 2 is an end view of a lamp cartridge of the interior lighting assembly of FIG. 1;

FIG. 3 is a cross-sectional view of the lamp cartridge of FIG. 2 taken along line 3-3 of FIG. 2;

FIG. 4 is a cross-sectional view of the lamp cartridge of FIGS. 2 and 3 taken along line 4-4 of FIG. 3 and with a cold cathode tube of the cartridge removed for clarity;

FIG. 5 is a schematic block diagram of the cold cathode tube of the lamp cartridge of FIGS. 2-4, an inverter ballast of the interior lighting assembly of FIG. 1, a key pad, and associate electrical interconnections between them;

FIG. 6 is a fragmentary perspective view of a series of lamp cartridges constructed according to the invention mounted in a series of receptacles formed in cornice lighting fixtures with the fixtures shown installed in a bus;

FIG. 7 is an end view of an interior lighting assembly constructed according to an alternative embodiment of the invention with a removable cartridge of the assembly shown detached from a receptacle of the assembly; and

FIG. 8 is a fragmentary end view of a bus-mounted interior lighting assembly constructed according to another alternative embodiment of the invention.

### DETAILED DESCRIPTION OF INVENTION EMBODIMENT(S)

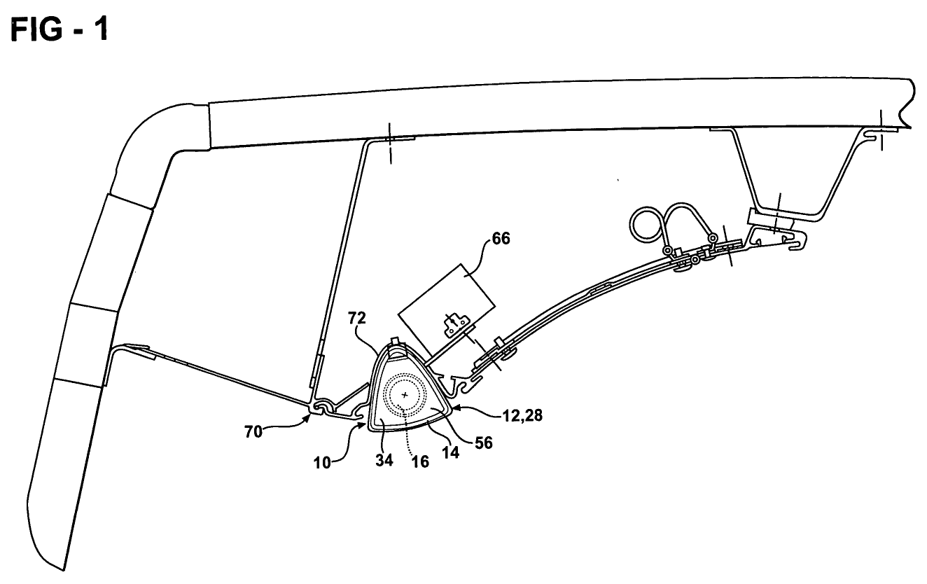

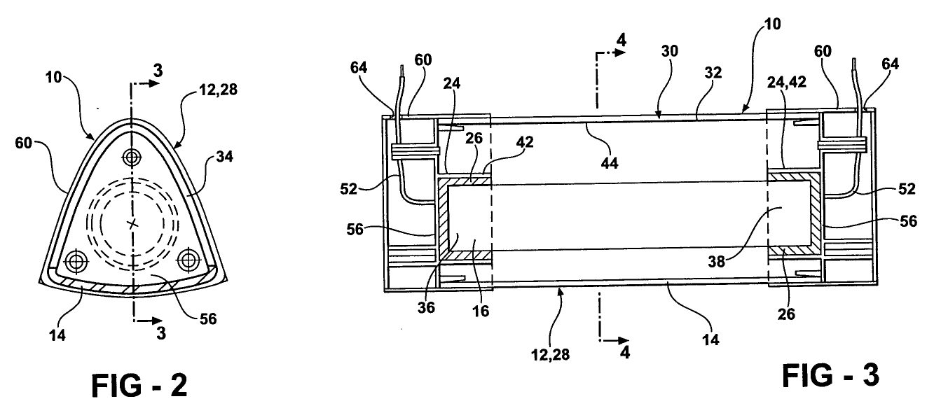

A vehicle interior lighting assembly constructed according to the invention is shown at 10 in FIGS. 1-8. The assembly 10 includes a lamp housing 12 having a lens 14 and a cold cathode discharge tube 16 carried by the lamp housing 12. The tube 16 emits light through the lens 14 when energized by electrical current. The assembly 10 also includes a current path 18 extending from an external power source 19 to the cold cathode discharge tube 16. The current path 18 delivers sufficient electrical current from the source 19 to the cold cathode tube 16 to illuminate the cold cathode tube 16. The lamp housing 12 supports the cold cathode tube 16 in a vehicle compartment 20 and protects the cold cathode tube 16 from breakage due to flexing of a vehicle 22 that the assembly 10 is installed in. The lamp housing 12 does this by protecting the cold cathode tube 16 from the transmission of associated resulting torsional, shock, vibration, and or longitudinal bending forces from the vehicle 22, through the lamp housing 12, to the cold cathode tube 16.

Details regarding the operation, construction, and available models of cold cathode discharge tubes suitable to be employed in an interior lighting assembly constructed according to the invention are included in the following publications that are incorporated herein by reference: National Cathode Corp. Home Page, http://www.lighting-inc.com/manufacturers/nationalcathode/html; What is Cold Cathode?, http://www.lighting-inc.com/manufacturers/nationalcathode/whatis.html; .Cold Cathode Fluorescent Lamps; http://www.nelt.co.jp/nhe hp/cfl/cfl.html; Compact Fluorescent Lamps; http:/www.eren.doe.gov/consumerinfo/refbriefs/ef2.html;

As best shown in FIG. 3, the housing 12 includes a pair of lamp support bushings 24 supported at axially opposite ends of the housing 12 as shown in FIG. 3. The lamp support bushings 24 support respective opposite ends of the cold cathode discharge tube 16 and limit torsional, shock, vibration, bending, longitudinally compressive, and tensile forces that the housing 12 may apply to the cold cathode tube 16 as the housing 12 flexes with a vehicle 22 the housing 12 is supported on. Each bushing 24 includes a flexible annular cuff 26 comprising polyurethane foam or any other suitable shock absorbing material.

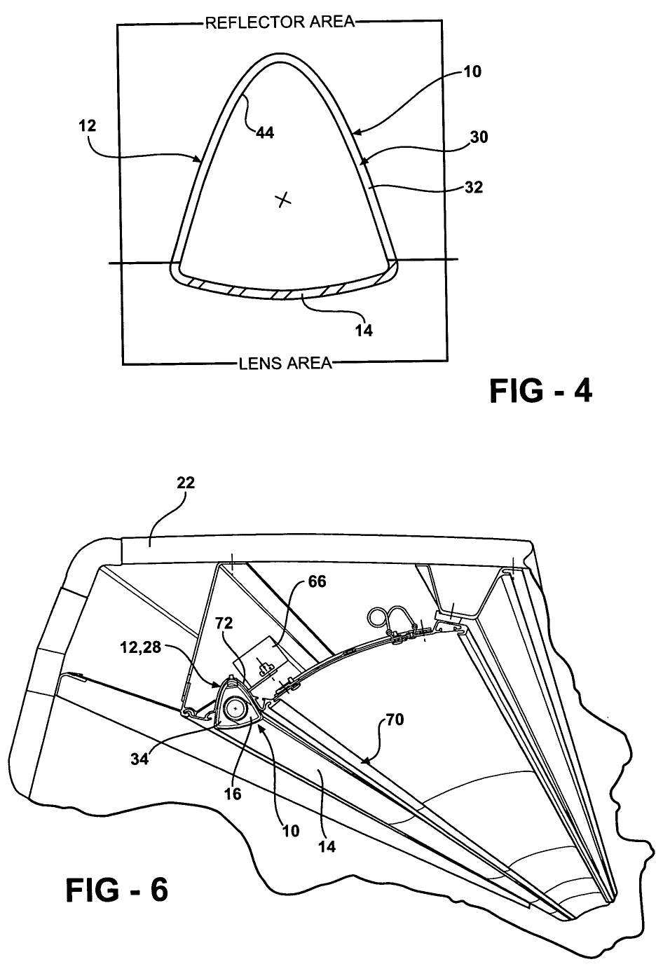

In the embodiment shown in the drawings, the housing 12 includes a self-contained lamp cartridge 28. As best shown in FIG. 4, the lamp cartridge 28 comprises an extruded polycarbonate lens/reflector tube 30. The lens/reflector tube 30 includes both the lens 14 and a reflector portion 32 that is co-extruded with the lens 14. In other embodiments, the lens 14 and reflector 32 may be extruded separately, then joined together by sonic weld or other suitable means.

As is also best shown in FIG. 3, the housing 12 also comprises a pair of end caps 34 that close off opposite ends 36, 38 of the lens/reflector tube 30 by being glued to the respective lens/reflector tube ends 36, 38 using a suitable cement 40. The end caps 34 are shaped to include axially inwardly extending cups 42 that support the lamp support bushings 24. The cups 42 support the bushings 24 in relative positions that allow the bushings 24 to support the cold cathode discharge tube 16 in a position spaced from a continuous inner wall 44 of the lens/reflector tube 30. This arrangement prevents the lens/reflector tube 30 from contact 46ing and transmitting or applying side forces directly to the cold cathode tube 16 when the lens/reflector tube 30 is bent.

Each of the current paths 18 includes a contact 46 coupled to one of two electrodes 48, 50 of the cold cathode discharge tube 16. Each current path 18 also includes a wire 52 that is coupled to and extends from one of the contacts 46 and is connectable to a vehicle electrical power distribution system 54. The wires 52 extend out of the cartridge 28 through respective end wall portions 56 of the end caps 34.

Each of the end caps 34 includes a wire shield 60 that extends axially from around an outer edge of the end wall portion 56 of each end cap 34. When abutted axially against a wall or another lamp cartridge end cap 34, the wire shields 60 block passenger access to the electrical wires 52 that lead from the housing 12 to the vehicle electrical power system 54. The electrical wires 52 extend through holes 64 in the respective wire shields 60 as shown in FIG. 3.

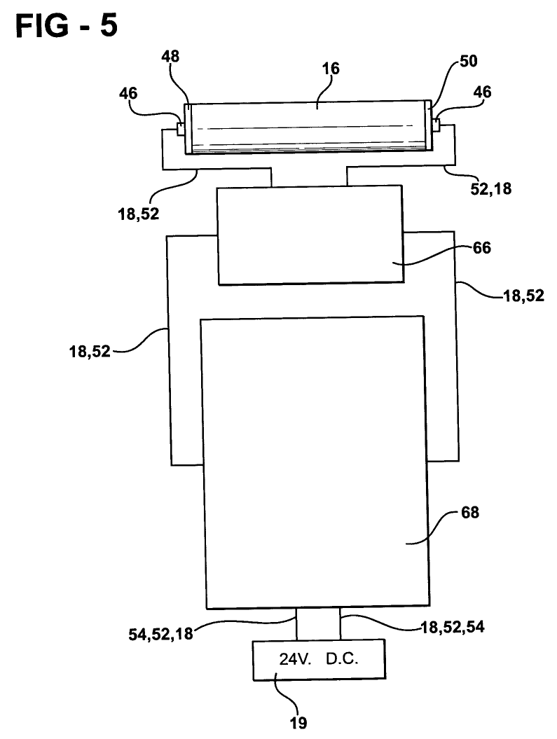

As shown in FIG. 5, between the vehicle power source 19 and the cold cathode tube 16, the assembly 10 includes an inverter ballast 66 and a keypad 68. The inverter ballast 66 converts electric power received from the vehicle power source 19 to whatever current and potential values are compatible with a cold cathode tube 16 to be used in the assembly 10, and inverts the power to provide alternating current. The keypad 68 is connected between the inverter ballast 66 and the vehicle power source 19 and provides control for each individual fixture, e.g., on-off and dimming.

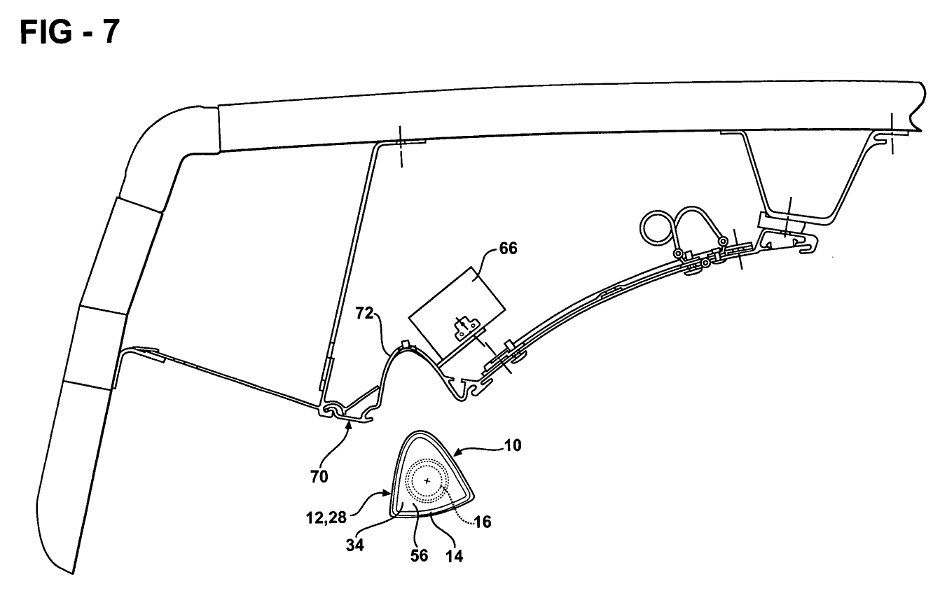

To receive and support the cartridge 28 in a desired position for illuminating a vehicle compartment 20, the assembly 10 includes a vehicle interior lighting fixture 70 including a receptacle 72 that receives the cartridge 28. As shown in FIG. 1, a wall of the receptacle 72 is contoured to complement the shape of the reflector portion 32 of the lens/reflector tube 30 to maximize contact area between the receptacle 72 and the cartridge 28. In the embodiment shown in the drawings, the cartridge 28 is riveted into the receptacle 72. Rivets are passed through and hold together the receptacle 72 and the reflector portion 32 of the lens/reflector tube 30. In the embodiment shown in FIG. 7, the cartridge 28 may be removably received by the receptacle 72 rather than fixed in place by rivets so that the cold cathode discharge tube 16 and cartridge 28 can be removed and replaced as a unit when damaged or rendered inoperative.

The cartridge 28 is sealed to prevent contaminants such as dust and insects from inhibiting or otherwise modifying the emission of light from the cartridge 28 and for ease of maintenance and cleaning. In the present embodiment the cartridge 28 is also hermetically sealed to prevent water vapor from entering the housing 12 and clouding the lens 14.

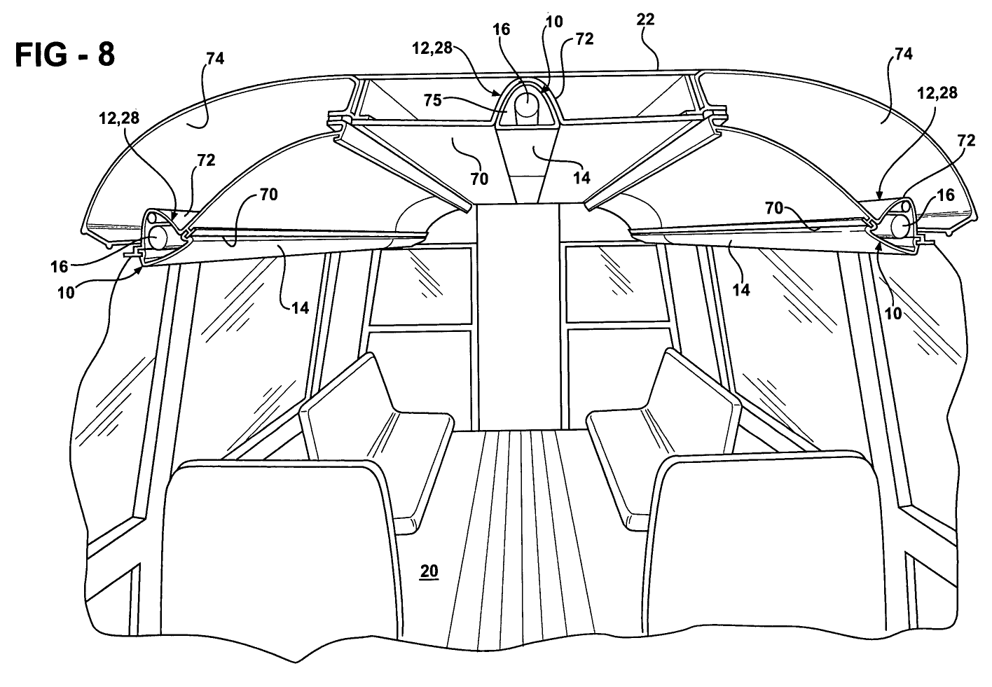

As shown in FIG. 6, a plurality of the above-described lamp cartridges 28 may be arranged end-to-end and longitudinally along an elongated vehicle interior compartment 20. As shown in FIG. 8, the cartridges 28 may be arranged end-to-end and longitudinally along both cornice areas 74 of a vehicle interior compartment 20. The receptacles 72 of the vehicle lighting fixtures 70 shown in FIGS. 6 and 8 are configured to receive and support the cartridges 28 longitudinally along a vehicle 22 passenger compartment 20 in an end-to-end arrangement. This arrangement provides an extended line of illumination in a desired position along the length of such a compartment 20. As shown in FIG. 8, the longitudinal arrangement may also be in the form of center strip lighting 75 supported along a longitudinal centerline of the ceiling of a vehicle compartment 20 as shown in FIG. 8.

A lamp cartridge 28 of the type described above may be installed in an existing vehicle lighting system without significant modification to the existing system. According to the method, the cartridge 28 is formed and shaped to fit within a lamp housing 12 of the existing system. The custom-shaped cartridge 28 is then installed in the lamp housing 12 and is connected to an electrical distribution system 54 of the vehicle 22. The cartridge 28 may be installed using rivets as described above or by any other suitable means known in the art.

This description is intended to illustrate certain embodiments of the invention rather than to limit the invention. Therefore, it uses descriptive rather than limiting words.

Obviously, it's possible to modify this invention from what the description teaches. Within the scope of the claims, one may practice the invention other than as described.

What is claimed is:

1. A vehicle interior lighting assembly for illuminating the interior of a vehicle, the assembly comprising:
a lamp housing having a lens;
a cold cathode discharge tube carried by the lamp housing, the tube being configured to emit light through the lens when energized by electrical current;
current paths extending from respective electrodes of the cold cathode discharge tube, connectable to an external power source 19, and configured to deliver electrical current from the source 19 to the tube sufficient to illuminate the tube; and
the lamp housing being configured to support and protect the tube from breakage in the passenger compartment of a vehicle that flexes and transmits related forces to the assembly causing the housing to flex.

2. A vehicle interior lighting assembly as defined in claim 1 in which the housing including a pair of lamp support bushings disposed at opposite ends of the housing and supporting opposite ends of a cold cathode discharge tube, the bushings being configured to limit forces that the housing can apply to the tube as the housing flexes with a vehicle the housing is supported on.

3. A vehicle interior lighting assembly as defined in claim 2 in which each bushing includes a flexible annular cuff configured to receive an end of a cold cathode tube and to flexibly support the tube.

4. A vehicle interior lighting assembly as defined in claim 2 in which each bushing comprises polyurethane foam.

5. A vehicle interior lighting assembly as defined in claim 1 in which the housing comprises an extruded polycarbonate lens/reflector tube.

6. A vehicle interior lighting assembly as defined in claim 1 in which the tube includes the lens and a reflector portion that is co-extruded with the lens.

7. A vehicle interior lighting assembly as defined in claim 1 in which the lens and reflector are extruded separately, then joined together.

8. A vehicle interior lighting assembly as defined in claim 7 in which the lens and reflector are joined together by a sonic weld.

9. A vehicle interior lighting assembly as defined in claim 2 in which the housing comprises a pair of end caps configured to close opposite ends of the tube and to carry the lamp support bushings in positions such that the bushings support the cold cathode discharge tube in a position spaced from a continuous inner wall of the lens/reflector tube.

10. A vehicle interior lighting assembly as defined in claim 9 in which at least one of the end caps includes a wire shield that extends axially from a wall portion of the end cap and is configured to block passenger access to electrical wiring leading from the housing to a vehicle power source 19.

11. A vehicle interior lighting assembly as defined in claim 1 in which the assembly includes a plurality of the tubes and the lamp housings arranged end-to-end and longitudinally along an elongated vehicle interior compartment.

12. A vehicle interior lighting assembly as defined in claim 1 in which:
the lamp housing is a removable self-contained cartridge; and
the assembly includes a vehicle lighting fixture including a receptacle configured to removably receive the cartridge, the cartridge being removable and replaceable as a unit while carrying a cold cathode discharge tube.

13. A vehicle interior lighting assembly as defined in claim 12 in which the cartridge is sealed against the intrusion of fine particulate matter.

14. A vehicle interior lighting assembly as defined in claim 13 in which the cartridge is hermetically sealed.

15. A vehicle interior lighting assembly as defined in claim 12 in which:
the assembly includes a plurality of the cartridges; and
the vehicle lighting fixture includes a receptacle configured to receive and support the cartridges longitudinally along a vehicle passenger compartment in an end-to-end arrangement.

16. A vehicle interior lighting assembly as defined in claim 12 in which:
the assembly includes a plurality of the cartridges; and
the vehicle lighting fixture includes a receptacle configured to removably receive and support the cartridges longitudinally along a vehicle passenger compartment in an end-to-end arrangement.

17. A vehicle interior lighting assembly as defined in claim 9 in which each current path includes:
an electrical contact supported in one of the end caps and coupled to one of two electrodes of the cold cathode discharge tube; and
a wire that is coupled to and extends from the contact and is connectable to a vehicle electrical power distribution system.

18. A method for installing a lamp cartridge in an existing lighting system, the method including the steps of:
providing a vehicle having an existing interior lighting fixture comprising a lamp housing for receiving a lamp;
forming a cartridge shaped to fit within the lamp housing;
providing the cartridge in the lamp housing; and
connecting the cartridge to the vehicle electrical system.
